(19) United States
(12) Patent Application Publication
(10) Pub. No.: US 2008/0094556 A1
(43) Pub. Date: Apr. 24, 2008

(54) Birefringent layers with tilted optical axis

(75) Inventors: Bianca Maria Irma Van Der Zande, Eindhoven (NL); Emiel Peeters, Eindhoven (NL); Hendrik Johannes Boudewijn Jagt, Eindhoven (NL); Ciska Doornkamp, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/598,206

(22) PCT Filed: Feb. 24, 2005
(86) PCT No.: PCT/IB05/50683

§ 371 Date: Aug. 21, 2006

(30) Foreign Application Priority Data
Mar. 1, 2004 (EP) 04100802.0

(51) Int. Cl. G02B 1/02; G02F 1/1334

(52) U.S. Cl. 349/117; 430/20

(57) ABSTRACT

A method for the manufacture of a birefringent layer with tilted optical axis, comprising providing a liquid crystal mixture comprising liquid crystal molecules and a volatile surfactant, aligning said liquid crystal mixture, and evaporate at least part of said volatile compound from the mixture to alter the tilt of the optical axis of said liquid crystal mixture.

### FIELD OF THE INVENTION

The present invention relates to methods for the manufacture of birefringent layers with tilted optical axis and to display devices comprising such birefringent layers.

### TECHNICAL BACKGROUND

The angular dependence of contrast values for liquid crystal displays is a limiting factor for the usefulness of liquid crystal displays since the contrast is severely reduced at oblique viewing angles. However, the angular dependence can be improved (reduced) by introducing optical retarder foils, with birefringence complementary to the birefringence of the liquid crystal molecules in the liquid crystal cell in the dark state.

Conventional uniaxial or biaxial retarder foils are usually prepared by stretching polymer films (for example polycarbonate or polyvinylalcohol). Liquid crystalline monomers and polymers can also be used for the preparation of birefringent foils. As described by Mori et al, Jpn J Appl Phys, 36:143 (1997) and in U.S. Pat. No. 5,518,783, negatively birefringent foils based on discotic liquid crystalline polymers may be effective as compensation foils. An optical retardation foil with a tilted optical axis can be the result of either a splayed director pattern of the liquid crystal molecules or a constant tilt.

Van de Witte et al, Jpn J Appl Phys 38:748 (1999) discloses optical foils with tilted optical axis, prepared by making use of the difference in alignment of the liquid crystalline monomers at the liquid crystal-air interface and the liquid-substrate interface on which the alignment is fixed. The tilt of the optic axis can be adjusted by changing the liquid crystalline mixture composition.

One drawback of this method is that the liquid crystal mixture has to be adjusted in order to change the tilt, and it has been proven to reproduce badly. Moreover, the tilt direction of the optical axis is hard to control, leading to undesired domain formation in the optical foil.

### SUMMARY OF THE INVENTION

An object of the present invention is to overcome the drawbacks of the aforementioned methods to produce optical birefringent layers with tilted optical axis based on liquid crystal monomers or polymers.

Thus the present invention provides a method for the manufacture of a birefringent layer with tilted optical axis comprising, providing a liquid crystalline mixture comprising liquid crystal molecules and a volatile surfactant, aligning said liquid crystalline mixture, and evaporating at least part of said volatile compound from the mixture to alter the tilt of the optical axis of the liquid crystal material.

According to the invention, the liquid crystal mixture preferably comprises a polymerisable compound, preferably a photo-polymerisable compound, more preferably photo-polymerisable liquid crystal molecules, and preferably said method further comprises polymerizing said polymerisable compound. Polymerization of the liquid crystalline layer provides a polymerized birefringent layer, a foil, having the obtained altered optical tilt.

One advantage of the present invention is that different layers with different tilt angles reproducibly can be obtained by just changing the evaporation conditions, without changing the composition of the liquid crystal mixture.

Another advantage of the present invention is that the tilt in the manufactured layer has a well controlled direction, preventing unwanted domain formation in the layer.

The present invention also relates to liquid crystal displays comprising birefingent polymerized layers, foils, and the use of such layers for the manufacture of liquid crystal displays.

### BRIEF DESCRIPTION OF THE DRAWINGS

FIG. 1 shows the retardation vs. viewing angle for birefringent layers produced according to example 1 with different annealing (heating) times.

FIG. 2 shows the macroscopic (average) tilt of the director (°) vs. annealing time for birefringent layers produced according to example 1.

FIG. 3 shows a schematic drawing of a method according to the invention.

### DETAILED DESCRIPTION OF THE INVENTION

The present invention relates to a method for the manufacture of a birefringent layer with tilted optical axis, said method comprising:

providing a liquid crystalline mixture comprising liquid crystal molecules and a volatile surfactant;

aligning said liquid crystalline mixture; and

evaporate at least part of said volatile compound from the mixture to alter the tilt of the optical axis of the liquid crystalline material.

Preferably the above method also comprises providing a substrate, e.g. a glass or polymer substrate, preferably comprising an alignment layer, and aligning said mixture on said support, preferably on said alignment layer. The alignment layer can be a rubbed polyimide, photo-aligned, ion milled, plasma treated or inorganic film or any other alignment layer known by those skilled in the art, but aligning the liquid crystalline mixture is also possible without the use of an alignment layer, e.g. by applying an electric or magnetic field.

As used herein, the term “tilt” generally refers to the angle between a surface, e.g. the surface on which the liquid crystal material is applied and the director of a certain number of molecules in the material. However the term “optical tilt” or “tilt of the optical axis” refers to the angle between the surface and the optical axis of a certain numbers of molecules in the material.

The local tilt/optical tilt, refers to the tilt at a specific location in the material, i.e. at a certain distance from the substrate.

The average tilt/average optical tilt refers the average of the tilt values over the depth of the material in a certain area.

The liquid crystalline mixture comprises polymerisable liquid crystal molecules, a volatile surfactant and optionally photo-initiator and inhibitor, preferably dissolved in a suitable solvent, such as xylene, 2-butanone, toluene, N-methylpyrollidone, γ-butyrolactone or suitable other solvents known to those skilled in the art. The mixture may comprise one or several different type(s) of liquid crystal molecules, preferably reactive liquid crystal monomers.

Suitable reactive liquid crystal molecules comprises calamitic liquid crystalline molecules containing one or more polymerizable groups, preferred groups include acrylates, methacrylates, vinylether, oxetane, epoxy or thiolene. Exampels of such reactive liquid crystalline molecules comprises, but are not limited to, RM 257 and RM 82. Other liquid crystal molecules suitable for use with the present invention are known to those skilled in the art.

Furthermore, the mixture comprises a volatile surfactant, that preferably provides a planar alignment at the mixture-air interface. Preferably the volatile surfactants are perflouoronated surfactants having a perfluoroalkyl chain attached to a polar head-group. Since the perfluoronated chain is not very compatible with the bulk of the liquid crystalline material, the surfactant wants to phase-separate from the liquid crystal molecules and will accumulate in micelles or at the mixture-air interface of the film. The surfactant is present in the liquid crystalline material in small amounts, typically about 1%. Examples of such surfactants include, but are not limited to, 2-n-ethylperfluoro-octanesulfonamido)-ethylacrylate, commercially available from Acros and FC151, commercially available from Merck. Other suitable volatile surfactants recognizable to those skilled in the art may also be used with the present invention.

The volatile surfactant is such that it evaporates from the liquid crystal mixture at elevated temperatures and/or at reduced pressures.

In preferred embodiments of the invention the liqud crystalline mixture is polymerisable, preferably photo-polymerisable, and the mixture preferably comprises an initiator which can induce the polymerization process, preferably a photo-initator such as Irgacure 184, available from Ciba Geigy, Irgacure 651, or other suitable initiators known to those skilled in the art.

Preferably, the mixture is applied on said alignment layer, for example by spin-coating, spray coating, printing, blade coating or other suitable methods, whereby an aligned layer with a well defined orientation of the liquid crystal molecules is obtained. Preferably said alignment layer provides an almost planar alignment of the of the liquid crystalline mixture, i.e. wherein the local tilt of the aligned liquid crystal mixture at the substrate is preferably about 0° to 10°, more preferably about 1 to 10°. However, higher tilts than 10° can be obtained.

During the above coating process, essentially all of the solvent evaporates from the liquid crystalline mixture.

After the mixture is applied to a surface, the surfactant will predominantly be located at the film-air interface. The surfactants are oriented in such a way that their perfluoronated chains are pointed towards the air while the polar head-group is pointed to the liquid crystalline layer. By this orientation of the surfactants, the surface energy is minimized.

Evaporation of the volatile compound is preferably effected by heating the mixture to a temperature where the volatile compound evaporates from the mixture at a desired evaporation rate, preferably 40-100° C. For example for 2-n-ethylperfluoro-octanesulfonamido)-ethylacrylate, 70° C. is the preferred temperature. The evaporation may also be effected by reducing the pressure of the atmosphere surrounding the mixture.

Upon evaporation, the surface energy increases since the surface is no longer formed by the perfluoronated chains of the surfactants but by the liquid crystal molecules.

To minimize the surface energy, the liquid crystal molecules will point their aliphatic chains towards the air. This is accomplished as the liquid crystal molecules tilt until they are eventually in a homeotropic orientation. The result of the surface energy minimization is that there are two different boundary conditions for the liquid crystalline layer. At the substrate the alignment layer induces an essentially planar or slightly tilted orientation of the director, while at the air interface the director of the molecules are tilted or even stand upright. As a result of this, the local tilt of the director in the liquid crystalline layer increases with the distance from the substrate, thus forming a splayed layer.

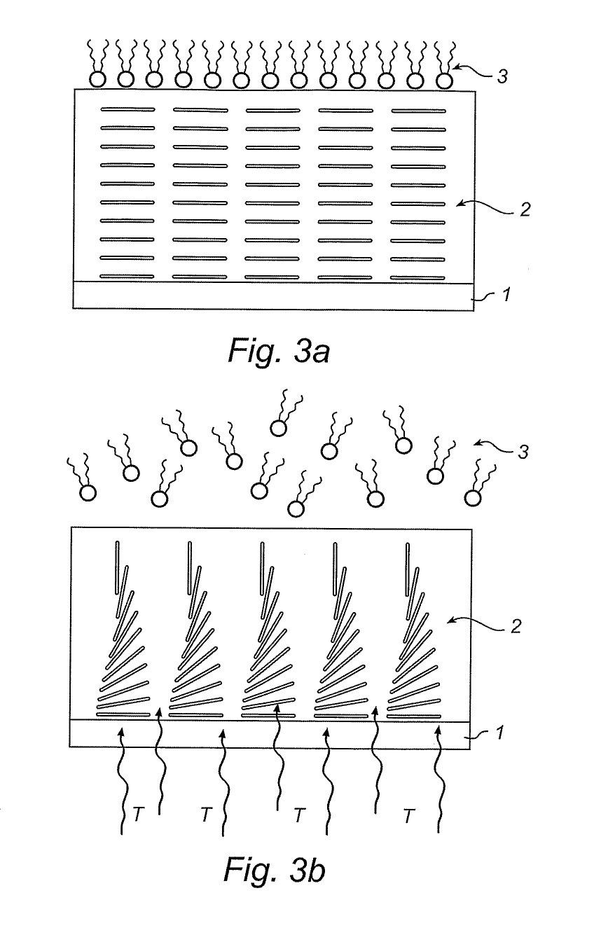

This is schematically shown in FIG. 3, wherein a liquid crystalline material 2 also comprising volatile surfactant 3 is deposited on a substrate 1. Initially, the surfactant is mainly located at the air-surface interface, where they arrange to minimize the surface energy, allowing the liquid crystal molecules to stay in an essentially planar arrangement. By heating the substrate, the surfactants vaporize, leaving liquid crystal molecules to minimize the surface energy, which they accomplish by tilting, thus forming a splayed layer.

As used herein, a “splayed” layer refers to a layer wherein the local tilt of the director either increases or decreases with the distance from the substrate.

However, in certain cases where the initial tilt at the substrate is high, the tilting of the liquid crystal molecules at surface, due to the surface energy minimization, may result in a liquid crystalline layer with a essentially constant, but high tilt.

Without the use of a surfactant in the initial mixture, it is difficult to control the direction of splay and different domains will be formed where the splay directions are different. By the use of a proper surfactant a mono-domain is formed since it will cost extra energy to form different domains with different splay directions. Hence, the mono-domain is preserved during the transition from planar to splayed and only one splay direction is obtained.

Presently, increases in average tilts of the director ranging from 1° to 20° have been obtained after the evaporating step when the initial tilt (before evaporation) was 2°, but still higher increases may very well be obtainable by methods according to the present invention.

In preferred embodiments of the present invention, the evaporation step is followed by a polymerization step. Preferably the mixture is photo-polymerisable, and in those cases the mixture is irradiated with light suitable for activating the initiator to induce polymerization. Due to polymerization, the configuration of the liquid crystal molecules obtained in the evaporation step is fixed in the obtained polymer. Thus a polymerized birefringent layer with splayed optical axis is obtained.

The method according to the present invention can also be used for the manufacture of a polymerized patterned birefringent layer, wherein said layer comprises at least two adjacent domains in which the configuration of the optical tilt differs. Such a layer can be manufactured by aligning a photo-polymerisable liquid crystalline mixture according to the invention on a substrate, illuminating said mixture through a mask, whereby the irradiated mixture polymerizes and the initial, preferably essentially planar, configuration becomes fixed in the irradiated domains. Subsequently, the surfactant is evaporated, thus obtaining a splayed configuration of the director in the non-polymerised domains, whereas the configuration in the polymerized domains remains fixed. Thereafter, the layer is again, optionally through a mask, illuminated with light, whereby the illuminated domains polymerizes, fixating the obtained splay in the illuminated domains.

The method may also be used to obtain a lateral gradient of average tilt angle in the layer by using a lateral thermal gradient to evaporate the surfactant. The higher the temperature, the more surfactant is evaporated, and the higher the average tilt will be.

The present invention also relates to liquid crystal displays comprising such a birefringent layer with tilted optical axis, preferably wherein the birefringent layer improves (reduces) the angular dependence of the contrast for such displays. The types of displays in which the polymerized birefringent layers may advantageously be used are known to those skilled in the art.

The following example is provided for illustrative purposes only and shall not be interpreted as limiting the invention.

### EXAMPLES

A reactive liquid crystal mixture was prepared by dissolving 1,4-di(4-(3-acryloyloxypropyloxy)benzoyloxy)-2-methylbenzene (1 g, reactive LC-monomer RM257 commercially available from Merck), 1,4-di(4-(6-acryloyloxyhexyloxy)benzoyloxy)-2-methylbenzene (0, 25 g, reactive LC-monomer RM82 commercially available from Merck), (4-(6-acryloyloxyhexyloxy)-4(hexyloxy)benzoyloxy) benzene (0, 25 g, a reactive LC-monomer), Irgacure 184 1-hydroxycyclohexylphenylketone) (0, 02 g, a photoinitiator commercially available from Ciba Geigy, Switzerland), and (2-n-ethylperfluoro-octanesulfonamido)-ethylacrylate (0, 01 g, a surfactant to obtain a planar alignment, commercially available from Acros) into 2.0 g xylene at 70° C.

The mixture was spin-coated on top of a substrate provided with an alignment layer being a rubbed polyimide. The spin-coating conditions was 40 s at 1200 rpm, yielding a film with a retardation of about 600 mn. The rubbed polyimide establishes nearly planar alignment in a mono-domain of the LC monomers in the rubbing direction. The liquid crystal film was subsequently heated at 75° C. for various times ranging from 1 to 10 min. Finally, the configuration obtained was fixed by UV mask exposure for 5 min in a nitrogen atmosphere (20 mW/cm²).

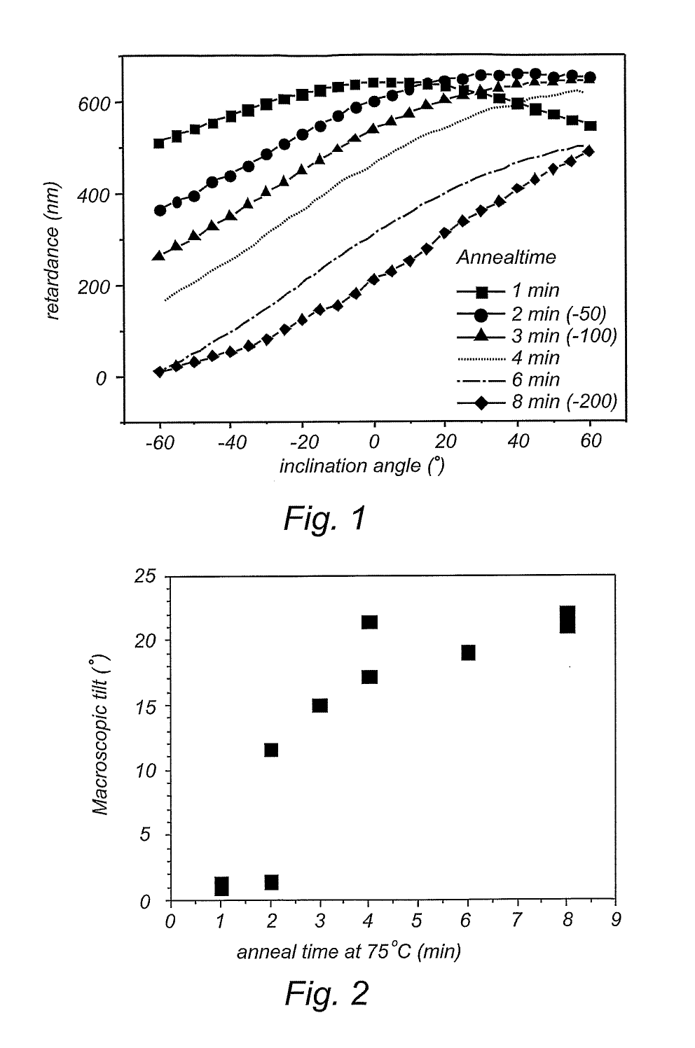

FIG. 1 shows the retardation vs. viewing angle for different annealing times wherein a clear difference is visible between different annealing times.

FIG. 2 shows the macroscopic tilt of the film for different heating times, and the tilt is clearly depending on the annealing time.

1. A method for the manufacture of a birefringent layer with tilted optical axis, comprising:
providing a liquid crystal mixture comprising liquid crystal molecules and a volatile surfactant,
aligning said liquid crystal mixture, and
evaporate at least part of said volatile compound from the mixture to alter the tilt of the optical axis of said liquid crystal mixture.

2. A method according to claim 1, further comprising providing a substrate with an alignment layer and aligning said liquid crystal mixture on said alignment layer.

3. A method according to claim 1, wherein said aligning gives an alignment with a tilt of 0 to 10° of said liquid crystal molecules.

4. A method according to claim 1, wherein said liquid crystal mixture comprises a polymerisable compound and wherein said method further comprises polymerizing said polymerisable compound.

5. A method according to claim 4, wherein said polymerisable compound is said liquid crystal molecules.

6. A method according to claim 5, wherein said polymerisable liquid crystal molecules are selected from calamitic liquid crystalline molecules comprising one or more polymerizable groups selected from acrylate, methacrylate, vinylether, oxetane, epoxy, thiolene and any combinations thereof.

7. A method according to claim 4, wherein said polymerisable compound is photo-polymerisable.

8. A method according to claim 1, wherein said surfactant comprises a perfluoronated group.

9. A method according to claim 8, wherein said surfactant is 2-n-ethylperfluoro-octanesulfonamido)-ethylacrylate.

10. A method according to claim 1, wherein said volatile surfactant is evaporated by heating said liquid crystal mixture.

11. A method according to claim 10, wherein said volatile surfactant is evaporated at a temperature ranging from 40-100° C.

12. A method according to claim 1, wherein said volatile surfactant is evaporated by decreasing the pressure of the atmosphere surrounding said liquid crystal mixture.

13. A method for manufacturing a liquid crystal display, comprising the step of incorporating in said liquid crystal display a birefringent layer obtainable by the method according to claim 1.

14. A liquid crystal display comprising a birefringent layer obtainable by the method according to claim 1.

15. A birefringent layer obtainable by the method according to claim 1.
